(19) United States
(12) Patent Application Publication
(10) Pub. No.: US 2012/0219767 A1
(43) Pub. Date: Aug. 30, 2012

(54) FLUOROPOLYMER FILMS AND METHODS FOR MAKING THE SAME

(75) Inventors: Yuan-Ping Robert Ting, Plainsboro, NJ (US); Simon J. Porter, Allentown, PA (US); Carl E. Altman, Morristown, NJ (US); Eric J. Rainal, Morristown, NJ (US); Samuel M. Julian, Schuylkill Haven, PA (US); James I. Fryer, Morristown, NJ (US)

(73) Assignee: HONEYWELL INTERNATIONAL INC., Morristown, NJ (US)

(21) Appl. No.: 13/361,714

(22) Filed: Jan. 30, 2012

Related U.S. Application Data
(60) Provisional application No. 61/446,752, filed on Feb. 25, 2011.

(51) Int. Cl. B32B 3/00; C08L 27/20; C08L 27/16; C08L 27/18; B32B 27/00; B32B 7/12

(52) U.S. Cl. 428/195.1; 428/421; 428/343; 525/199

(57) ABSTRACT

Embodiments of films and methods for making the films are provided. The film comprises a fluoropolymer layer having a surface and comprising a melt processable fluoropolymer and a functionalized polymer dispersed throughout the fluoropolymer layer. A portion of the functionalized polymer is disposed at the surface of the fluoropolymer layer for bonding to a second layer.

### CROSS-REFERENCE TO RELATED APPLICATIONS

This application is related to and claims all available benefit of U.S. Provisional Patent Application 61/446,752 filed Feb. 25, 2011, the entire contents of which are herein incorporated by reference.

### FIELD OF THE INVENTION

The present invention relates generally to polymer films and methods for making polymer films, and more particularly relates to films having a fluoropolymer layer with improved adhesion, and methods for making these films.

### BACKGROUND OF THE INVENTION

Fluoropolymers are a class of paraffinic thermoplastic polymers that have some or all of the hydrogen replaced with fluorine. Fluoropolymers are well known for their inertness to most chemicals and resistance to high temperature, as well as their low coefficients of friction. Most fluoropolymers, especially polychlorotrifluoroethylene (PCTFE) and ethylene-chlorotrifluoroethylene copolymer (ECTFE), exhibit excellent barrier properties, making them exceptionally good polymers as a barrier packaging material as well as for many other applications. However, fluoropolymers do not adhere robustly to most other materials and, in fact, are known for their nonstick characteristics.

Accordingly, it is desirable to provide films having a fluoropolymer layer that more robustly adheres to a second layer of material. Moreover, it is desirable to provide a method for making such films. Furthermore, other desirable features and characteristics of the present invention will become apparent from the subsequent detailed description of the invention and the appended claims, taken in conjunction with the accompanying drawings and this background of the invention.

### SUMMARY OF THE INVENTION

Films and methods for making films are provided herein. In accordance with an exemplary embodiment, a film comprises a fluoropolymer layer having a surface and comprising a melt processable fluoropolymer and a functionalized polymer dispersed throughout the fluoropolymer layer. A portion of the functionalized polymer is disposed at the surface of the fluoropolymer layer for bonding to a second layer.

In accordance with another exemplary embodiment, a method for making a film is provided. The method comprises the steps of melt blending a functionalized polymer with a melt processable fluoropolymer to form a fluoropolymer blend. A fluoropolymer layer is formed from the fluoropolymer blend such that the fluoropolymer layer has the functionalized polymer dispersed throughout the fluoropolymer layer and a portion of the functionalized polymer is disposed at a surface of the fluoropolymer layer for bonding to a second layer.

### DETAILED DESCRIPTION

The following Detailed Description is merely exemplary in nature and is not intended to limit the invention or the application and uses of the invention. Furthermore, there is no intention to be bound by any theory presented in the preceding Background of the Invention or the following Detailed Description.

The various embodiments contemplated herein relate to films having a fluoropolymer layer that can robustly adhere to a second layer of material and methods for making such films. As used herein, the term “film” refers to single layer films, multilayer films, sheets, and laminates, all of which may have a flat and/or contoured shape. The various embodiments of the film comprise a fluoropolymer layer that is formed by melt blending a functionalized polymer with a melt processable fluoropolymer to form a fluoropolymer blend and shaping the fluoropolymer blend into a layer. The melt blending process incorporates the functionalized polymer into the melt processable fluoropolymer in a molten state such that the functionalized polymer is dispersed throughout the fluoropolymer blend including at the surface of the formed fluoropolymer layer.

By itself, the melt processable fluoropolymer has a relatively low surface energy due to its lack of functionality, e.g., lack of functional groups other than the fluorine. Therefore, the melt processable fluoropolymer has low adhesive properties without a surface treatment (e.g., plasma, corona, etc.). The functionalized polymer, however, when incorporated into the fluoropolymer layer increases the adhesion of the fluoropolymer layer's surface to the surface of a second layer of material. In an exemplary embodiment, the functionalized polymer contains one or more functional groups, such as, for example, a carbonyl moiety, a carboxylic acid moiety, an amine moiety, a hydroxyl moiety, combinations thereof, and the like, that can form bonds, e.g., chemical or covalent bonds, with another material. Preferably, a portion of the functionalized polymer is at the surface of the fluoropolymer layer where the functional groups are present to bond with an adjacent second layer of material. The inventors have found that if the functionalized polymer is present in an relatively small but effective amount, the concentration of the functionalized polymer at the surface of the fluoropolymer layer is suitable for forming bonds with a second layer of material to robustly adhere the second layer to the fluoropolymer layer without diminishing the desirable properties (e.g. barrier properties, etc.) of the fluoropolymer.

In an exemplary embodiment, the melt processable fluoropolymer, which can include blends of melt processable fluoropolymers, is present in an amount of from about 80 to about 99.5 weight percent (wt. %), and preferably about 90 to about 99 wt. %, of the fluoropolymer layer. In particular, the melt processable fluoropolymer is a fluoropolymer that may be melted without substantially deteriorating the fluoropolymer. Some non-limiting examples of melt processable fluoropolymers are polychlorotrifluoroethylene, ethylene-chlorotrifluoroethylene copolymer, polyvinylidene fluoride, tetrafluoroethylene-perfluoro (alkyl vinyl ether) copolymer, tetrafluoroethylene-hexafluoropropylene copolymer, and tetrafluoroethylene-ethylene copolymer. Other melt processable fluoropolymers known to those skilled in the art may also be used. Alternatively, polytetrafluoroethylene (e.g., Teflon®) is an example of a fluoropolymer that is not typically melt processable because it substantially degrades when it is melted.

In an exemplary embodiment, the functionalized polymer is present in an amount of about 0.5 to about 20 wt. %, and preferably in an amount of about 1 to about 5 wt. % of the fluoropolymer layer. The functionalized polymer includes, but is not limited to, gycidyl methacrylate polymers such as copolymers of ethylene-gycidyl methacrylate and terpolymers of ethylene-acrylic ester-gycidyl methacrylate, terpolymers of ethylene-acrylic ester-maleic anhydride including terpolymers of ethylene-ethyl acrylate-maleic anhydride, alkyl ester copolymers, modified polyolefins, and mixtures thereof. The gycidyl methacrylate polymers including the copolymers of ethylene-gycidyl methacrylate and the terpolymers of ethylene-acrylic ester-gycidyl methacrylate, and the terpolymers of ethylene-acrylic ester-maleic anhydride including the terpolymers of ethylene-ethyl acrylate-maleic anhydride, are commercially available under the trade name Lotader® resins, which are manufactured by Arkema Inc. located in Philadelphia, Pa.

The alkyl ester copolymers include copolymers of an olefin having about 2 to about 8 carbon atoms and an α, β-ethylenically unsaturated carboxylic acid having the following formula:

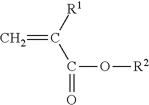

wherein R¹ is H or an alkyl group having 1 to 5 carbon atoms, and R² is H or an alkyl group having 1 to 12 carbon atoms.

The alkyl ester copolymers can be produced in accordance with the processes well known in the art including forming random, block and graft copolymers. Those production processes include, but are not limited to, the ones described in U.S. Pat. No. 3,350,372 issued to Anspon (“Anspon”). As disclosed in Anspon, the alkyl ester copolymers in accordance with the present invention can be prepared by a continuous polymerization of an olefin of about 2 to about 8 carbon atoms and an alkyl ester of an α, β-ethylenically unsaturated carboxylic acid in the presence of a free radical polymerization initiator such as lauroyl peroxide or capryl peroxide. The olefins that may be used to form the alkyl ester copolymers include olefins having between 2 and 8 carbon atoms. Non-limiting examples of suitable olefins include ethylene, propylene, butylene, pentene-1,3-methylbutene-1,4-methylpentene-1, and hexene. Preferably, the olefins are ethylene, propylene, and butylene, and most preferably the olefin is ethylene.

The alkyl esters of an α, β-ethylenically unsaturated carboxylic acid that may be used to form the alkyl ester copolymers include, but are not limited to, methyl acrylate, ethyl acrylate, butyl acrylate, 2-ethylhexyl acrylate, decyl acrylate, octadecyl acrylate, methyl methacrylate, ethyl metacrylate, butyl methacrylate, 2-ethylhexyl methacrylate, decyl methacrylate, and octadecyl methacrylate. Of these, the preferred are methyl acrylate, ethyl acrylate, butyl acrylate, methyl methacrylate, ethyl methacrylate, and butyl methacrylate, and more preferred are methyl acrylate, methyl methacrylate, butyl acrylate, and butyl methacrylate.

Non-limiting examples of the alkyl ester copolymers that may be used include ethylene-methyl acrylate, ethylene-ethyl acrylate, ethylene-butyl acrylate, ethylene-2-ethylhexyl acrylate, ethylene-decyl acrylate, ethylene-octadecyl acrylate, ethylene-methyl methacrylate, ethylene-ethyl methacrylate, ethylene-butyl methacrylate, ethylene-2-ethylhexyl methacrylate, ethylene-decyl methacrylate, ethylene-octadecyl methacrylate, and copolymers and mixtures thereof. Of these, the preferred are ethylene-methyl acrylate, ethylene-ethyl acrylate, ethylene-butyl acrylate, ethylene-methyl methacrylate, ethylene-ethyl methacrylate, ethylene-butyl methacrylate, and copolymers and mixtures thereof including ethylene-methyl acrylateethylene-butyl acrylate copolymer. Of these, the more preferred are ethylene-methyl acrylate, ethylene-methyl methacrylate, ethylene-butyl acrylate, ethylene-butyl methacrylate, and copolymers and mixtures thereof. The preferred alkyl ester copolymer comprises from about 5 to about 50 wt. % of the alkyl ester, based on the total weight of the alkyl ester copolymer. More preferably, the alkyl ester comprises from about 5 to about 40 wt. %, and most preferably from about 10 and about 30 wt. %, based on the total weight of the alkyl ester copolymer.

In an exemplary embodiment, the alkyl ester copolymers are further modified to contain up to 5 wt. %, preferably up to 3 wt. %, and more preferably up to 1 wt. %, of unsaturated polycarboxylic acids and/or their anhydrides. Such unsaturated polycarboxylic acids and their anhydrides include maleic acid, maleic anhydride, fumaric acid, crotonic acid, citraconic anhydride, itaconic anhydride and the like. Of these, the most preferred is maleic anhydride.

In an exemplary embodiment, the functionalized polymer includes modified polyolefin compositions having at least one functional moiety selected from the group consisting of unsaturated polycarboxylic acids and acid anhydrides. The polyolefins that may be used to form the modified reaction product of the modified polyolefin compositions contemplated herein include polyolefins and their copolymers where the olefin monomers have between about 2 and about 8 carbon atoms. Non-limiting examples of suitable polyolefins include low, medium or high density polyethylene, linear low density polyethylene, polypropylene, polybutylene, polypentene-1, poly-3-methylbutene-1, poly-4-methylpentene-1, polyhexene-1, and copolymers and mixtures thereof. Of these, the preferred polyolefins are polyethylene, polypropylene, polybutylene, and copolymers and mixtures thereof.

The modified polyolefin compositions suitable for use herein include copolymers and graft copolymers of a polyolefin and a constituent having a functional moiety selected from the group consisting of unsaturated polycarboxylic acids and acid anhydrides thereof. The unsaturated polycarboxylic acids and anhydrides include maleic acid, maleic anhydride, fumaric acid, crotonic acid, citraconic anhydride, itaconic anhydride and the like. Of those, the preferred are anhydrides, of which the most preferred is maleic anhydride.

In an exemplary embodiment, the preferred modified polyolefin composition comprises from about 0.001 to about 10 wt. % of the functional moiety, based on the total weight of the modified polyolefin. More preferably, the functional moiety comprises from about 0.005 to about 5 wt. %, and most preferably from about 0.01 to about 2 wt. %, based on the total weight of the modified polyolefin.

The modified polyolefin compositions contemplated herein can be produced with the processes known in the art, including but not limited to the processes described in U.S. Pat. Nos. 3,481,910, 3,480,580, 4,612,155 and 4,751,270. As described, the processes include a graft polymerization reaction generally performed by standard graft polymerization techniques known in the art. Such processes comprise heating a mixture of a polyolefin, a monomer of the functional moiety, and a free radical initiator and kneading to a temperature at which the polyolefin becomes molten to facilitate graft polymerization of the functional moiety. Alternatively, the above-stated compounds can be dissolved or suspended in an appropriate solvent to perform the graft polymerization reaction.

In an exemplary embodiment, the modified polyolefin composition further comprises preferably up to about 40 wt. %, based on the total weight of the modified polyolefin, of vinyl acetate. More preferably, the modified polyolefin comprises from about 4 to about 30 wt. % of vinyl acetate, and most preferably from about 5 to about 25 wt. % of vinyl acetate, based on the total weight of the modified polyolefin.

The modified polyolefin compositions contemplated herein may also contain up to about 40 wt. % of at least one thermoplastic elastomer such as ethylene-propylene rubber, ethylene-1-butene rubber, butyl rubber, butadiene rubber, styrene-butadiene rubber, ethylene-butadiene rubber, isopropene rubber, isobutylene or the like. Preferably, the thermoplastic elastomers are ethylene-propylene rubber and isobutylene rubber. The thermoplastic elastomers may also be modified with a constituent having a functional moiety selected from the group consisting of unsaturated polycarboxylic acids and acid anhydrides thereof.

In an exemplary embodiment, the film is a multilayer film comprising the fluoropolymer layer (with the functionalized polymer) as discussed in the foregoing paragraphs, and a second layer that is adhered to the surface of the fluoropolymer layer. In particular, a portion of the functionalized polymer is disposed at the surface of the fluoropolymer layer and is bonded to the second layer. Preferably, the second layer of material has formed chemical bonds at the surface interface with the functional groups of the functionalized polymer. Alternatively, the functionalized polymer may increase the surface energy and/or stickiness of the surface of the fluoropolymer layer such that when the second layer is brought into contact with the fluoropolymer layer (e.g., via a coextrusion process, a lamination process or a coating process) the two layers adhere to each other, such as, for example, via a melt-fusion bond (e.g. produced during the coextrusion process) or a pressure sensitive bond (e.g. produced during the lamination process).

Non-limiting examples of the second layer include a thermoplastic layer, a metal foil layer (e.g. a metal foil lid for a “blister” packaging structure for medicaments), a printed surface layer, and an adhesive layer that may be adhered to a third layer of material, such as, in the case of a multilayer structure having three or more layers. The second layer may be continuous and/or completely cover the surface of the fluoropolymer layer, or alternatively, may be discontinuous and/or partially cover the surface of the fluoropolymer layer, such as, in the case where the second layer of material has been printed onto the fluoropolymer layer surface.

The thermoplastic layer may be any thermoplastic film or thermoplastic film-forming polymer known to those skilled in the art. Non-limiting examples for such films and polymers include: cellulosic polymers including cellulose acetate, cellulose triacetate, cellulose acetate butyrate, cellulose propionate, ethyl cellulose, cellophane; ionomers; polyamides including nylon 6, nylon 6,6, nylon 11, and nylon 12 as well as polyamide copolymers and mixtures thereof; polycarbonate; polyesters, including polyalkylene terephthalates, such as polybutylene terephthalate, polyethylene terephthalate, as well as polyester copolymers, particularly those copolymers comprising ethylene terephthalate with at least one additional comonomer, including cyclohexanedimethanol-modified polyethylene terephthalate (PETG); polyolefins, including polybutylene, polypropylene, polyethylenes including low density polyethylene, medium density polyethylene, high density polyethylene, ultrahigh molecular weight polyethylene, ethylene copolymers, polybutylene and the like; polyimides; polystyrene; polyurethane; polyvinyl chloride; polysulfone; ethylene-vinyl acetate copolymers; acrylonitrile butadiene-styrene; rubber modified acrylonitrile methyl acrylate copolymer; homopolymers and ethylene copolymers of acrylates; vinyl chloride-acetate copolymer; vinylidene chloride-vinyl chloride copolymer; vinyl nitrile rubber alloys; and copolymers and mixtures thereof, as well as others not particularly noted here. Of these thermoplastic films and film-forming polymers, the preferred are polyesters, polyolefins, polyamides and mixtures thereof, and the more preferred are polyesters, including polybutylene terephthalate, polyethylene terephthalate and cyclohexanedimethanol-modified polyethylene terephthalate.

As noted above, the second layer can be an adhesive layer. The adhesive layer may be formed from any suitable thermoplastic adhesive, chain extending thermal cure adhesive, and/or thermoset adhesive. In an exemplary embodiment, the adhesive layer is formed from a chain extending thermal cure adhesive that chemically reacts with the functionalized polymer during the film forming and adhesive curing phases. Non-limiting examples of adhesives for forming the adhesive layer include acrylic adhesive, poly(methyl methacrylate) adhesive, cyanoacrylate adhesive, epoxy adhesive, polyurethane adhesive, silicones adhesive, phenolic adhesive, polyimide adhesive, and mixtures thereof.

In an exemplary embodiment, the film is a multilayer film comprising a fluoropolymer layer, a thermoplastic layer and an adhesive layer that is interposed between the fluoropolymer layer and the thermoplastic layer. The adhesive layer is bonded to the fluoropolymer layer as discussed in the foregoing paragraph.

In an exemplary embodiment, a method for making a fluoropolymer film contemplated herein includes melt blending the functionalized polymer with the melt processable fluoropolymer to form a fluoropolymer blend. In one example, solid resin pellets of the functionalized polymer and solid resin pellets of the melt processable fluoropolymer are melted and blended together to form the fluoropolymer blend. Non-limiting examples of various techniques for melt blending to form the fluoropolymer blend are high shear mixing and/or heated mixing, such as, for example, in the heating, mixing and/or screw-mixing zones of extrusion processes, coextrusion processes, injection molding processes and extrusion blow molding processes, as are well known in the art. Other techniques known to those skilled in the art for melting and blending polymers together may also be used.

A fluoropolymer layer is formed from the fluoropolymer blend such that the fluoropolymer layer has the functionalized polymer dispersed throughout the fluoropolymer layer and a portion of the functionalized polymer is disposed at the surface of the fluoropolymer layer. Non-limiting examples of various techniques for shaping the fluoropolymer layer typically use a die, form or mold and include extrusion processes, coextrusion processes, injection molding processes, and extrusion blow molding processes, as are well known in the art. Alternatively, or in addition to the above processes, the fluoropolymer layer may be formed by a lamination process, a film casting process, a thermoforming process, or any other suitable process known to those skilled in the art for film forming.

Provided below are a series of tables illustrating the results of a study conducted to evaluate the bond strength of multilayer structured films having a fluoropolymer layer in accordance with various embodiments. Table 1 provides the bond strength results for various multilayer films samples comprising a layer of polyethylene terephthalate (PET) bonded to a layer of Halar® using various adhesives as an interposing adhesive layer. Halar® is a melt processable fluoropolymer of ethylene-chlorotrifluoroethylene copolymer (ECTFE) manufactured by Solvay Solexis, Inc. headquartered in Brussels. The various grades of adhesives were all two-part chain-extending thermal cure polyurethanes. The bond strengths were determined by peeling 1 inch wide samples using a 180° T-peel test and measuring the pounds force required to peel the PET layer from the adhesive layer that was also bonded to the ECTFE fluoropolymer layer.

Table 2 provides the bond strength results for multilayer films comprising a layer of polyethylene terephthalate (PET) bonded to a fluoropolymer layer of ECTFE modified with about 5 wt. % of a maleic anhydride modified ethylene ethylacrylate copolymer using various adhesives as an interposing adhesive layer. The various grades of adhesives were all two-part chain extending thermal cure polyurethanes. The samples were post cured at about 120° F. for about 5 days. The bond strengths were determined by peeling 1 inch wide samples using a 180° T-peel test and measuring the pounds force required to peel the PET layer from the adhesive layer that was also bonded to the ECTFE modified with terpolymer of ethylene-acrylic ester-maleic anhydride fluoropolymer layer.

Table 3 provides the bond strength results for multilayer films comprising a layer of polyethylene terephthalate (PET) bonded to a fluoropolymer layer of ECTFE modified with about 5 wt. % of a maleic anhydride modified polyolefin using various adhesives as an interposing adhesive layer. The various grades of adhesives were all two-part chain extending thermal cure polyurethanes. The samples were post cured at about 120° F. for about 5 days. The bond strengths were determined by peeling 1 inch wide samples using a 180° T-peel test and measuring the pounds force required to peel the PET layer from the adhesive layer that was also bonded to the ECTFE modified with maleic anhydride polyolefin fluoropolymer layer.

Tables 1-3 are as follows:

TABLE 1

| | | | Bond Strength (10 mil |
|---|---|---|---|
| | | | PET to 1.5 mil White |
| Sample ID | Additive | Adhesive Type | Halar) - lb/in |
| 1 | None | Two parts polyester | 0.2 |
| | | urethane A | |
| 2 | None | Two parts polyether | 0.1 |
| | | urethane A | |
| 3 | None | Two parts polyester | 0.1 |
| | | urethane B | |
| 4 | None | Two parts polyester | 0.3 |
| | | urethane C | |
| 5 | None | Two parts polyester | 0.3 |
| | | urethane D | |
| 6 | None | two parts polyester | 0.2 |
| | | urethane adhesive E | |
| 7 | None | two parts polyester | 0.1 |
| | | urethane adhesive F | |

TABLE 2

| | | | Bond Strength (10 mil |
|---|---|---|---|
| | | | PET to 1.5 mil White |
| Sample ID | Additive | Adhesive Type | mod-Halar) - lb/in |
| 8 | 5% EEA-MAH | Two parts polyester | 3.3 |
| | | urethane A | |
| 9 | 5% EEA-MAH | Two parts polyether | 2.9 |
| | | urethane A | |
| 10 | 5% EEA-MAH | Two parts polyester | 3.6 |
| | | urethane B | |
| 11 | 5% EEA-MAH | Two parts polyester | 2.6 |
| | | urethane C | |
| 12 | 5% EEA-MAH | Two parts polyester | 3.6 |
| | | urethane D | |
| 13 | 5% EEA-MAH | two parts polyester | 3.4 |
| | | urethane adhesive E | |
| 14 | 5% EEA-MAH | two parts polyester | 2.8 |
| | | urethane adhesive F | |

TABLE 3

| | | | Bond Strength (10 mil |
|---|---|---|---|
| | | | PET to 1.5 mil White |
| Sample ID | Additive | Adhesive Type | mod-Halar) - lb/in |
| 15 | 5% MAH-PE | Two parts polyester | 0.2 |
| | | urethane A | |
| 16 | 5% MAH-PE | Two parts polyether | 0.04 |
| | | urethane A | |
| 17 | 5% MAH-PE | Two parts polyester | 3.4 |
| | | urethane B | |
| 18 | 5% MAH-PE | Two parts polyester | 0.2 |
| | | urethane C | |
| 19 | 5% MAH-PE | Two parts polyester | 0.2 |
| | | urethane D | |
| 20 | 5% MAH-PE | two parts polyester | 0.2 |
| | | urethane adhesive E | |
| 21 | 5% MAH-PE | two parts polyester | 3.6 |
| | | urethane adhesive F | |

For the samples tested and reported in Table 1, the failure mode for all of the multilayer films having the unmodified ECTFE fluoropolymer layer resulted in the adhesive layer delaminating from the unmodified ECTFE fluoropolymer layer (hereinafter “adhesion failure”) indicating very poor adhesion between the two layers. The poor adhesion results are also indicated by the relatively low maximum bond strength values of about 0.1 to about 0.3 pounds per inch (lb/in).

For the samples tested and reported in Table 2, none of the failure modes for the multilayer films having the ECTFE modified with maleic anhydride modified ethylene ethylacrylate copolymer fluoropolymer layer resulted in an adhesion failure. Rather, in the majority of the multilayer samples, the adhesion between the adhesive layer and the ECTFE modified maleic anhydride modified ethylene ethylacrylate copolymer fluoropolymer layer was so great that it resulted in tearing of the modified fluoropolymer layer. These excellent adhesion results are indicated by the relatively high maximum bond strength values of about 2.8 to about 3.6 lb/in.

Table 3 also shows overall better adhesion results between the adhesive layer and the fluoropolymer layer than those shown in Table 1, although not as good as a result shown in Table 2. In particular, the maximum bond strength values ranged from about 0.2 to about 3.6 lb/in.

Accordingly, films having a fluoropolymer layer that can robustly adhere to a second layer of material, and methods for making such films have been described. The various embodiments comprise a fluoropolymer layer that is formed by melt blending a functionalized polymer with a melt processable fluoropolymer to form a fluoropolymer blend and shaping the fluoropolymer blend into a layer. The melt blending process incorporates the functionalized polymer into the melt processable fluoropolymer in a molten state such that the functionalized polymer is disbursed throughout the fluoropolymer blend including at the surface of the formed fluoropolymer layer. The functionalized polymer preferably increases the functionality and/or adhesiveness of the layer's surface for adhesion to a second layer of material. In an exemplary embodiment, the functionalized polymer contains one or more functional groups that can form bonds, e.g., chemical or covalent bonds, with another material. Preferably, a portion of the functionalized polymer is at the surface of the fluoropolymer layer where the functional groups are present to bond with an adjacent second layer of material. Its has been found that if the functionalized polymer is present in an relatively small but effective amount, the concentration of the functionalized polymer at the surface of the fluoropolymer layer is suitable for forming bonds with the second layer of material to robustly adhere the second layer to the fluoropolymer layer without diminishing the desirable properties (e.g. barrier properties, etc.) of the fluoropolymer.

While at least one exemplary embodiment has been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention, it being understood that various changes may be made in the function and arrangement of elements described in an exemplary embodiment without departing from the scope of the invention as set forth in the appended Claims and their legal equivalents.

What is claimed is:

1. A film comprising:
a fluoropolymer layer having a surface and comprising a melt processable fluoropolymer and a functionalized polymer dispersed throughout the fluoropolymer layer, wherein a portion of the functionalized polymer is disposed at the surface of the fluoropolymer layer for bonding to a second layer, and wherein the melt processable fluoropolymer is present in an amount of from about 80 to about 99.5 wt. % of the fluoropolymer layer.

2. The film according to claim 1, wherein the functionalized polymer is present in an amount of from about 0.5 to about 20 wt. % of the fluoropolymer layer.

3. The film according to claim 1, wherein the melt processable fluoropolymer is present in an amount of from about 90 to about 99 wt. % of the fluoropolymer layer.

4. The film according to claim 1, wherein the melt processable fluoropolymer is selected from the group consisting of polychlorotrifluoroethylene, ethylene-chlorotrifluoroethylene copolymer, polyvinylidene fluoride, tetrafluoroethylene-perfluoro (alkyl vinyl ether) copolymer, tetrafluoroethylene-hexafluoropropylene copolymer, tetrafluoroethylene-ethylene copolymer, and mixtures thereof.

5. The film according to claim 1, wherein the functionalized polymer is selected from the group consisting of gycidyl methacrylate polymers including copolymers of ethylene-gycidyl methacrylate and terpolymers of ethylene-acrylic ester-gycidyl methacrylate, terpolymers of ethylene-acrylic ester-maleic anhydride including terpolymers of ethylene-ethyl acrylate-maleic anhydride, alkyl ester copolymers of an olefin having about 2 to about 8 carbon atoms and an α, β-ethylenically unsaturated carboxylic acid, modified polyolefins comprising an olefin having about 2 to about 8 carbon atoms and a functional moiety selected from the group consisting of unsaturated carboxylic acids and acid anhydrides, and mixtures thereof.

6. The film according to claim 5, wherein the modified polyolefin comprises the at least one functional moiety selected from the group consisting of maleic acid, maleic anhydride, fumaric acid, crotonic acid, citraconic anhydride, and itaconic anhydride, the at least one functional moiety present in an amount of from about 0.001 to about 10 wt. % of the modified polyolefin.

7. The film according to claim 5, wherein the modified polyolefin comprises polyethylene and maleic anhydride that are present in amounts of from about 90 to about 99.99 wt. % and from about 0.001 to about 10 wt. %, respectively, of the modified polyolefin.

8. The film according to claim 5, wherein the modified polyolefin comprises maleic anhydride, vinyl acetate, ethylene-propylene rubber and polyethylene, and wherein the maleic anhydride, the vinyl acetate and the ethylene-propylene are present in amounts of from about 0.001 to about 10 wt. %, up to about 40 wt. %, and up to about 40 wt. %, respectively, of the modified polyolefin, and a remaining portion of the modified polyolefin is polyethylene.

9. The film according to claim 5, wherein the alkyl ester copolymer comprises the olefin and the at least one α, β-ethylenically unsaturated carboxylic acid that are present in amounts of from about 50 to about 95 wt. % and from about 5 to about 50 wt. %, respectively, of the alkyl ester copolymer.

10. The film according to claim 5, wherein the alkyl ester copolymer is selected from the group consisting of ethylene-methyl acrylate, ethylene-ethyl acrylate, ethylene-methyl methacrylate, ethylene-ethyl methacrylate, ethylene-butyl acrylate, ethylene-butyl methacrylate, and copolymers and mixtures thereof.

11. The film according to claim 10, wherein the alkyl ester copolymer further comprises maleic anhydride present in an amount of up to about 1 wt. % of the alkyl ester copolymer.

12. The film according to claim 5, wherein the alkyl ester copolymer is ethylene-methyl acrylate copolymer.

13. The film according to claim 5, wherein the alkyl ester copolymer is a maleic anhydride modified ethylene-methyl acrylate copolymer.

14. The film according to claim 5, further comprising the second layer disposed adjacent to the fluoropolymer layer, wherein the portion of the functionalized polymer is bonded to the second layer.

15. The film according to claim 14, wherein the portion of the functionalized polymer is chemically bonded to the second layer.

16. The film according to claim 14, wherein the second layer is selected from the group consisting of an adhesive layer, a thermoplastic layer, a metal foil layer, and a printed surface layer.

17. The film according to claim 14, further comprising a thermoplastic layer, wherein the second layer is an adhesive layer that is interposed between the fluoropolymer layer and the second layer.

18. A method for making a film, the method comprising the steps of:
melt blending a functionalized polymer with a melt processable fluoropolymer to form a fluoropolymer blend; and
forming a fluoropolymer layer from the fluoropolymer blend such that the fluoropolymer layer has the functionalized polymer dispersed throughout the fluoropolymer layer and a portion of the functionalized polymer is disposed at a surface of the fluoropolymer layer for bonding to a second layer, wherein the melt processable fluoropolymer is present in an amount of from about 80 to about 99.5 wt. % of the fluoropolymer layer.

19. The method according to claim 18, wherein the step of melt blending includes introducing the functionalized polymer in an amount of from about 0.5 to about 20 wt. % of the fluoropolymer blend.

20. The method according to claim 18, wherein the step of melt blending includes melt blending the melt processable fluoropolymer selected from the group consisting of polychlorotrifluoroethylene, ethylene-chlorotrifluoroethylene copolymer, polyvinylidene fluoride, tetrafluoroethylene-perfluoro (alkyl vinyl ether) copolymer, tetrafluoroethylene-hexafluoropropylene copolymer, tetrafluoroethylene-ethylene copolymer, and mixtures thereof.
